(19) United States
(12) Patent Application Publication
(10) Pub. No.: US 2021/0039298 A1
(43) Pub. Date: Feb. 11, 2021

(54) Technology for monitoring an extruder or respectively an injection moulding machine

(71) Applicant: KRAUSSMAFFEI TECHNOLOGIES GMBH, München (DE)

(72) Inventor: Otto Skrabala, Karlsfeld (DE)

(21) Appl. No.: 16/767,228

(22) PCT Filed: Oct. 24, 2018
(86) PCT No.: PCT/EP2018/079154

§ 371 Date: May 27, 2020

(30) Foreign Application Priority Data
Dec. 8, 2017 (DE) 10 2017 129 232.2

(51) Int. Cl. B29C 48/92; B29C 45/76

(52) U.S. Cl. CPC B29C 48/92; B29C 45/76; B29C 2945/7619; B29C 2945/76367; B29C 2945/76488; B29C 2948/92228; B29C 2945/76846; B29C 2945/76933; B29C 2948/92209; B29C 2945/7604; B29C 2948/92266; B29C 2945/76668

(57) ABSTRACT

A measurement system for monitoring an extruder or an injection moulding machine in operation, with a measurement device that generates a radar wave signal and emits it in the extruder or in the injection moulding machine, and detects a response signal corresponding to the emitted radar wave signal; and an evaluation device, that determines a run time Δt, phase shift Δϕ and/or intensity change ΔI of the radar wave signal on the basis of the detected response signal, and determines at least one operating parameter of the extruder or of the injection moulding machine on the basis of the determined run time Δt, phase shift Δϕ and/or intensity change ΔI of the radar wave signal, wherein the operating parameter points to a wear state of the extruder) or of the injection moulding machine. Further, a corresponding method and an extruder and an injection moulding machine with such a measurement system.

The present invention relates to the fields of extrusion and injection moulding. In practical terms, a technology is provided for the monitoring of an extruder which is in operation, or of an injection moulding machine which is in operation.

Extrusion- and injection moulding methods have been used for a long time in the industrial production of shaped parts, in particular of plastic shaped parts. In the field of extrusion, single-screw extruders, double-screw extruders or multi-screw extruders can come into use here. Both methods have in common the fact that the plastic material which is to be processed in an extruder or in an injection moulding machine is melted and compacted by increasing the temperature and pressure, and is thus transferred into a plasticized (therefore deformable) state. The plasticized plastic material is subsequently pressed through a nozzle. The difference between extrusion and injection moulding lies substantially in the method of shaping the shaped parts. In extrusion, the plasticized plastic material is pressed through a shaping nozzle (die) or tool. The extruded shaped part which is thus obtained has in cross-section the shape of the nozzle which is used. In injection moulding, on the other hand, the plasticized plastic material is injected into a cavity of an injection moulding tool. The produced injection moulded shaped part therefore has the shape of the cavity of the injection moulding tool.

For checking a correct carrying out of the method in the production of plastic shaped parts by means of an extruder or respectively injection moulding machine, nowadays different measurement systems already come into use, which monitor process parameters, such as for example the pressure and the temperature of the plastic material which is received in the extruder or respectively in the injection moulding machine and is to be processed. Known measurement systems comprise contact thermometers and pressure sensors which are designed to monitor the temperature and the pressure of the material which is to be processed, in the feed zone, compression zone or respectively melting zone and ejection zone of the extruder.

From the dissertation by Heinrich Hömann with the title “Theoretische and experimentelle Betrachtung schnelllaufender Einschneckenextruder”, University of Paderborn 2014, in addition the use of pressure sensors is known, in order to measure the plasticizing state in conventional screw extruders. Here, pressure differences are detected here between the solid bed and the melt vortex in the extruder. From these pressure differences, a conclusion can then be drawn regarding the width of the solid bed and, under certain conditions, then a conclusion can be drawn regarding the solid content. Therefore, the measurement of the melting state is again based on a conventional pressure measurement. The described use of pressure sensors for measuring the melting state, however, is only expedient when a certain arrangement takes place between solid material and melt, namely a separation of melt and solid material. However, this separation does not take place in all extruders or respectively injection moulding machines. Therefore, the applicability of this method is greatly limited.

In addition, measurement systems are known, in which ultrasound comes into use. By ultrasound, elastic waves in the frequency range of 16 kHz to approximately 1 GHz are designated. They propagate in gases and liquids as a longitudinal wave and in solid bodies as a longitudinal and transverse wave. Viewed in physical terms, ultrasound is a wave of progressive mechanical deformation in a medium. As ultrasound does not represent an electromagnetic wave, but rather pressure- and density fluctuations in a medium, the propagation of ultrasonic waves and their measurement depends greatly on the state of the material to which ultrasound is applied, such as for example the density and temperature of the medium. Ultrasound can therefore be used for the determining of process parameters, such as for example of temperature or density or respectively density differences of the plastic material received in the extruder. By the measuring of density differences in addition also the dwell time of the plastic material which is to be extruded can be determined.

The measurement systems by means of ultrasound which are described here measure the influence of an elastic wave through the medium which is acted upon by ultrasound. The measurement signal is highly temperature-dependent here, because inter alia the propagation speed of the elastic waves is greatly determined through the temperature. In the extruder or respectively in the injection moulding machine, the temperature of the plastic material which is acted upon by ultrasound can greatly vary locally. The temperature varies here both in radial and also in axial direction, therefore, a characteristic of the plastic, such as for example its density or its melting state, can not be measured uncoupled from the temperature. This is a great disadvantage, because in particular in extruders the temperatures can greatly vary locally and therefore it can not be reliably established whether a signal change results from a change in the measurement quantity (for example the material density) or from a change in the temperature. In addition, frequently the actual temperature profile can not be determined at the respective measurement position. Therefore, it is often not possible to eliminate the influence of temperature on the measurement. Therefore, the suitability of ultrasound for the detection of characteristics of plastic (such as for example the measurement of density) is only suitable to a limited extent. Solely the determining of the temperature under the assumption of otherwise identical states of the plastic has become established.

In addition, it is known to measure the temperature during the extrusion outside the extruder. In such temperature measurement methods, conventional thermal elements, infrared thermometers or ultrasound (cf. DE 10 2009 004 946 A1) can come into use.

It is an object of the present invention to provide a technology for monitoring the operating state of an extruder or of an injection moulding machine. The technology is, in addition, to be able to be used for process monitoring and is to overcome the above-mentioned disadvantages in connection with known systems for process monitoring.

To solve this problem and other problems, a method is provided for monitoring an extruder which is in operation or an injection moulding machine which is in operation, wherein the method comprises the following steps: emitting a radar wave signal in the extruder or respectively in the injection moulding machine; detecting a response signal corresponding to the emitted radar wave signal; determining a run time, phase shift and/or intensity change of the radar wave signal on the basis of the detected response signal; and determining at least one operating parameter on the basis of the determined run time, phase shift and/or intensity change of the radar wave signal, wherein the operating parameter points to a wear state of the extruder or respectively of the injection moulding machine, to a phase state and/or to a material composition of a material which is received in the extruder or respectively in the injection moulding machine and is to be processed.

Phase state can mean in particular the melting state, therefore the ratio of solid to liquid phase of the material or material mixture.

The material which is received in the extruder or respectively in the injection moulding machine and is to be processed can be present as a single-component or multiple-component material (therefore as a material mixture of several components). In particular, the material which is received in the extruder or respectively in the injection moulding machine and is to be processed can be a plastic material or a plastic material mixture of at least two components, such as for example a mixture of several plastics or a mixture of plastic(s) and at least one filler or of plastic(s) and reinforcement fibres. For example, chalk can come into use as filler. Glass fibres, carbon fibres or natural fibres can come into use as reinforcement fibres. The use of recyclable plastic is also conceivable, which is prepared in the extruder or respectively in the injection moulding machine. In particular, thermoplastic plastics can come into use as plastic materials.

In contrast to the ultrasonic signals mentioned in the introduction, the emitted radar wave signal is an electromagnetic signal. It has been found that such an electromagnetic signal or respectively its response signal, compared to ultrasonic signals, depends considerably less on temperature fluctuations in the interior of the extruder, more precisely on temperature fluctuations in the material received in the extruder. The small influence of temperature fluctuations on the response signal can be disregarded in the method according to the invention.

A response signal means here the electromagnetic signal (or signal component) which is generated through the interaction of the irradiated radar signal with the material received in the extruder or respectively in the injection moulding machine and/or with extruder components or respectively injection moulding machine components. Depending on the implementation of the method, the response signal can represent the reflected component of the radar wave signal (e.g. an echo signal), which is reflected by the material which is to be extruded or by surfaces of extruder components (such as for example of an extruder screw) or by injection moulding machine components (for example a screw). Additionally or alternatively to this, the transmission signal of the irradiated radar wave signal, which passes through the material which is to be extruded, can also be evaluated as response signal.

In order to be able to monitor the operating state of the extruder or respectively of the injection moulding machine along its feed zone, compression zone or respectively melting zone and/or ejection zone, the radar wave signal can be emitted at several positions in the extruder or respectively in the injection moulding machine arranged spaced apart from one another in axial direction and/or radial direction. For each emission position, the response signal can be detected separately. On the basis of the response signal detected at each emission position, at least one operating parameter can then be determined.

The radar wave signal emitted at each position in the extruder or in the injection moulding machine can be emitted at a predetermined angle to the axial and/or radial direction of the extruder or respectively of the injection moulding machine. The axial direction corresponds here to the extrusion direction of the material which is to be extruded. Radial direction means the circumferential direction of the extruder or respectively of the injection moulding machine. According to a variant, the emission can take place substantially perpendicularly to the extrusion direction. Alternatively, the emission can also take place in an inclined manner to the extrusion direction.

The radar wave signal emitted at each position of the extruder can be a pulsed radar wave signal or a continuous radar wave signal. According to one implementation, a frequency-modulated continuous (FMCW) radar wave signal can be emitted.

The emitted radar wave signal can have at least a frequency in the range between 30 GHZ and 300 GHZ. With the use of a FMCW radar wave signal, the frequency of the emitted signal can alter periodically, wherein the emitted frequencies can lie in the frequency range between 30 GHz and 300 GHz.

From the emitted radar wave signal and from the detected response signal (radar wave echo signal or transmission signal), the run time, phase shift and/or intensity change of the emitted radar wave signal is determined as measurement parameter. These measurement parameters can be determined through comparison of the emitted radar wave signal (primary signal) and of the detected response signal. For example, the run time can be determined by measurement of the time covered between emission of the radar wave signal and detection of the corresponding response signal. The intensity change can be determined by forming the difference of the intensities of the emitted radar wave signal and of the detected response signal. Similarly, the phase shift can be determined by forming the difference of the phases of the emitted radar wave signal and of the detected response signal.

It was found that the above-mentioned measurement parameters depend on the material composition of the material received in the extruder or respectively injection moulding machine. The above-mentioned parameters can, in addition, also depend on the constitution of the extruder or respectively of the injection moulding machine. For example, the run time of the electromagnetic radar wave signal can depend on the material composition and on the phase state (melting state) of the material which is to be extruded. Likewise, the determined intensity change in the radar wave signal can provide information concerning the material composition and the phase state of the material which is to be extruded, because the absorption capacity of the material which is to be extruded generally depends on the material composition and/or on the phase state of the material which is to be extruded. In addition, the phase change can provide information concerning the constitution of boundary surfaces reflecting the radar wave signal (such as for example the surface of an extruder screw), because the phase of the reflected signal component can change depending on the constitution of the boundary surface.

According to one implementation, the refraction index of the material which is to be extruded and is received in the extruder or respectively injection moulding machine can be determined as operating parameter on the basis of the detected run time, phase shift and/or intensity change of the radar wave signal. It was found that the refraction index of a plurality of plastic materials, which come into use in extrusion and injection moulding methods, changes during the melting of the plastic material. When the composition of the plastic material is (approximately) known, then by determining the refraction index and with the aid of a refraction index model, the phase state of the plastic material in the extruder or respectively injection moulding machine can be determined. The refraction index model here can describe the development of the refraction index of the plastic material at the transition from the solid to the liquid phase of the plastic material. This development can be determined experimentally in preliminary tests or in real time (therefore during an extrusion process). The model can describe the refraction index development at the phase transition in the form of an analytic function or in the form of numerical data (for example in the form of a look-up table, which allocates determined refraction index values to corresponding melting state values).

Equally, the refraction index can depend on the material composition of a material mixture which is to be extruded. It was found that the refraction index shows a variation depending on the material concentration of the material mixture, when the starting materials of the material mixture have a different refraction index from one another. This is the case for a plurality of plastic mixtures. In particular, this also applies to a plurality of foamed or degassed plastics, wherein the refraction index depends on the concentration of the included foaming agent or respectively on the degasification state of the plastic which is to be extruded. When the melting state of the material mixture and the starting materials of the material mixture are (approximately) known, then the material composition can also be determined from the determined refraction index and by means of a refraction index model. The refraction index model can describe here the refraction index change as a function of the concentration of the starting materials. By means of the measured refraction index, therefore with knowledge of the nature of the starting materials, the material composition and/or the melting state of a plastic material which is to be extruded can be determined at or in the vicinity of each measurement position.

The refraction index can be determined directly from the detected run time of the radar wave signal, because the run time depends on the propagation speed Cm of the radar wave signal in the ray-penetrated material, and the propagation speed Cm is directly proportional to the refraction index n according to the relationship n=Cv/Cm, wherein Cv represents the propagation speed in vacuum. According to a continuation, in addition to the run time, intensity changes (caused by absorption in the ray-penetrated medium) and phase shifts between irradiated radar wave signal and response signal can be evaluated, in order to obtain conclusions concerning the refraction index.

According to a further implementation, a distance information can be determined as operating parameter from the determined run time, phase shift and/or intensity change. For example, in the case of an approximately known refraction index of the material which is to be extruded, distances can be determined between extruder components. For example, the radial distance of an extruder screw to the inner wall of the extruder housing receiving the extruder screw can be determined. From the determined distance values and the changes thereof, the wear state of the extruder screw can be determined.

The method described here and the implementations connected with the method can be carried out in real time. The wear of the extruder or respectively injection moulding machine, the material composition and the melting state of the material received in the extruder or respectively in the injection moulding machine can be monitored in real time during the extrusion process. The real time monitoring therefore enables a better carrying out of the process, because deviations from desired material compositions or melting states are recognized immediately and can be corrected by corresponding adjustment or readjustment of the process parameters.

To solve the above-mentioned problem, in addition a measurement system is provided. The measurement system comprises a measurement device which is designed to generate a radar wave signal and to emit it in the extruder or in the injection moulding machine, and to detect a response signal corresponding to the emitted radar wave signal; and an evaluation device, which is designed to determine a run time, phase shaft and/or intensity change of the radar wave signal on the basis of the detected response signal, and to determine at least one operating parameter of the extruder or of the injection moulding machine on the basis of the determined run time, phase shift and/or intensity change of the radar wave signal. The determined operating parameter points to a wear state of the extruder or injection moulding machine, to a phase state and/or to a material composition of a material which is received in the extruder or in the injection moulding machine and is to be processed.

The measurement device can comprise at least one radar wave transmitter, which is designed to generate a radar wave signal. According to a variant, the measurement device can comprise a plurality of radar wave transmitters arranged spatially at a distance from one another, which are respectively designed to generate a radar wave signal. Each radar wave transmitter of the measurement device can be arranged in the extruder (injection moulding machine) such that it is coupled electromagnetically with a material receiving channel of the extruder or respectively of the injection moulding machine. Electromagnetic coupling means that the radar wave signals generated by each radar wave transmitter are emitted directly (therefore without appreciable shielding losses through an extruder housing) onto the material which is received in the extruder channel and is to be processed.

Each radar wave transmitter can be designed to emit pulsed or continuous radar wave signals in the range between 30 GHz to 300 GHz. According to a variant, each radar wave transmitter can emit a FMCW signal.

In addition, the measurement device can comprise at least one radar wave receiver, which is designed for the detection of a response signal corresponding with the emitted radar wave signal. When the measurement device comprises a plurality of transmitters arranged spaced apart from one another, then a corresponding receiver can be provided for each transmitter. Radar wave transmitters and radar wave receivers can be arranged in the case of a radar wave echo measurement in the form of a radar wave transceiver at the same position in the extruder. With transmission measurement, transmitters and receivers can be arranged lying opposite in the extruder.

The evaluation device of the measurement system can be designed to determine the run time, phase shift and/or intensity change of the radar wave signal propagating through the material and/or the extruder components or the injection moulding machine on the basis of the detected response signal. In addition, the evaluation device can be designed to determine a refraction index of the material which is received in the extruder or in the injection moulding machine and which is to be processed, on the basis of the detected run time, phase shift and/or intensity change, and to determine the phase state and/or the material composition of the material by means of a predetermined refraction index model.

In addition, the evaluation device can be designed to determine, on the basis of the detected run time, phase shift and/or intensity change, distances between components of the extruder or of the injection moulding machine, and to determine the wear state of the extruder or of the injection moulding machine by means of a predetermined model.

In addition, an extruder and an injection moulding machine are provided, which respectively implement the measurement system described above. The extruder can be implemented here in the form of a single-screw extruder, double-screw extruder or multi-screw extruder. The measurement system can be arranged at or in the extruder or respectively at or in the injection moulding machine. In particular, transmitters and receivers of the measurement device can be arranged at or in the extruder or respectively injection moulding machine such that they are respectively coupled electromagnetically with the material receiving channel of the extruder or respectively of the injection moulding machine.

Further details and advantages of the invention will emerge with the aid of the following drawings, which represent implementations of the present invention. There are shown:

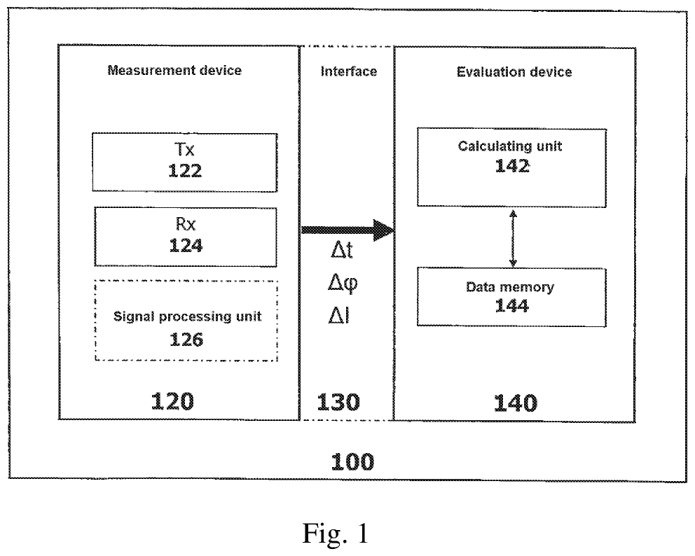

FIG. 1 a block diagram, which illustrates diagrammatically a measurement system for monitoring the operating state of an extruder or of an injection moulding machine according to the present invention;

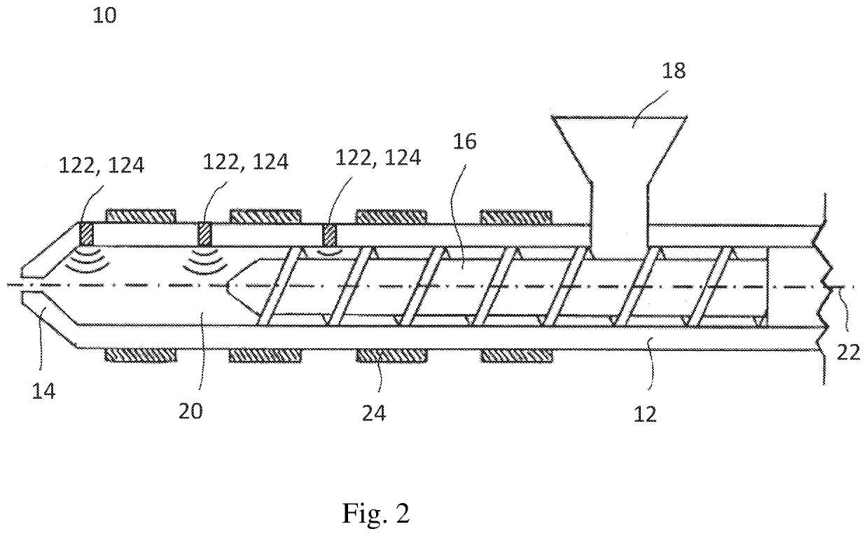

FIG. 2 a screw extruder, at which the measurement system shown in FIG. 1 is implemented by way of example;

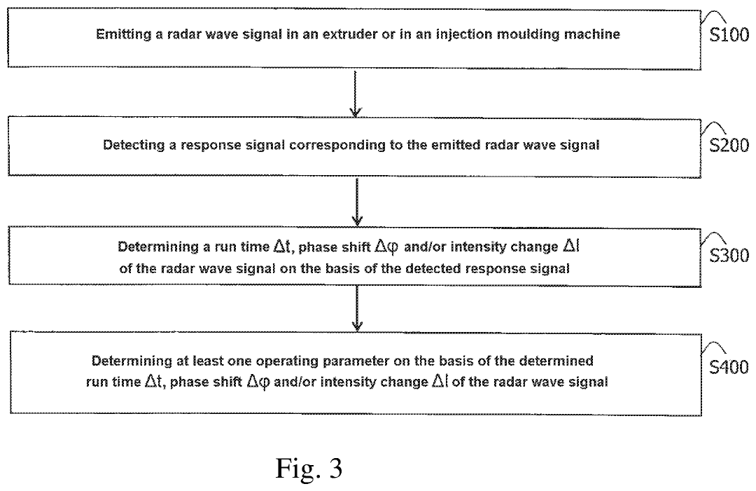

FIG. 3 a flow diagram, which illustrates a method for monitoring the operating state of an extruder or of an injection moulding machine;

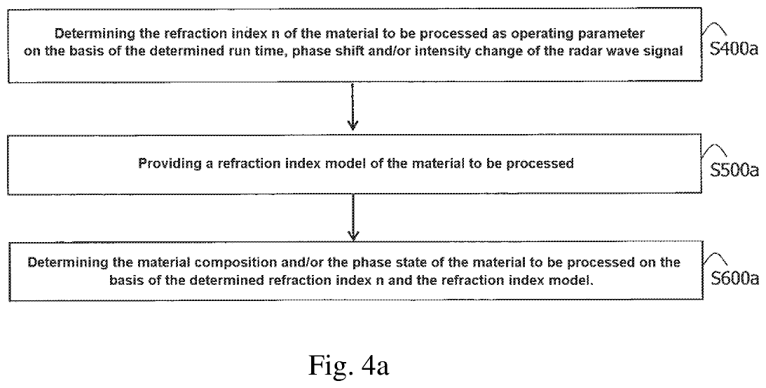

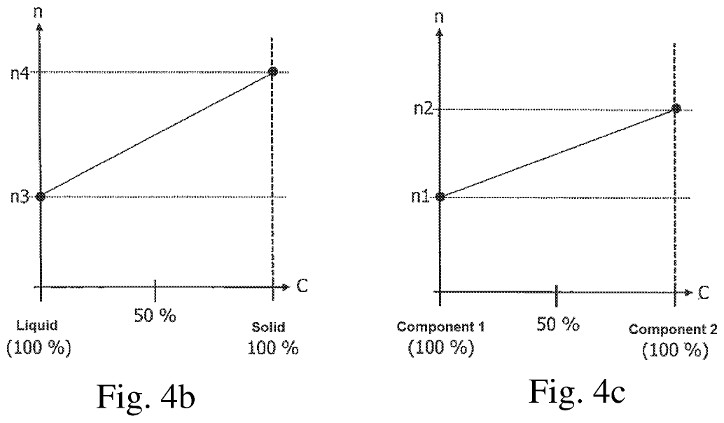

FIG. 4a-4c an implementation of the method according to FIG. 3; and

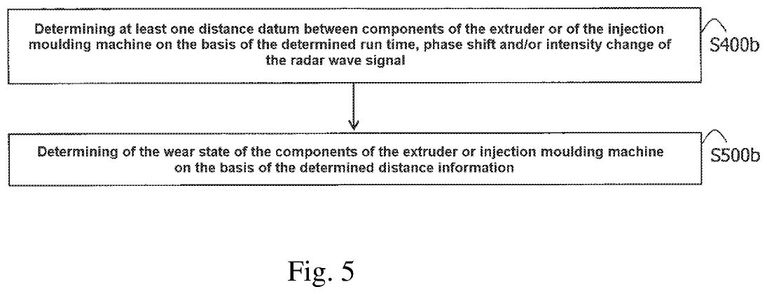

FIG. 5 a further implementation of the method according to FIG. 3.

In connection with FIG. 1 a measurement system 100 for monitoring the operation of an extruder or of an injection moulding machine according to the present invention is described further.

The measurement system 100 comprises a measurement device 120 and an evaluation device 140. When the measurement device 120 and evaluation device 140 are configured as separate units, the measurement system 100 can have in addition a (wired or wireless) interface 130, via which the devices 120, 140 communicate with one another. For example, the measurement device 120 can be arranged directly in an extruder or in an injection moulding machine, whereas the evaluation device is implemented in a computer arranged externally to the extruder or to the injection moulding machine. In FIG. 1 the communication interface is indicated by a dashed line. The transfer of measurement data from the measurement device 120 to the evaluation device 140 is indicated by an arrow.

The measurement device 120 shown in FIG. 1 comprises at least one transmitter Tx 122 and at least one associated receiver Rx 124. In FIG. 1 by way of example respectively one transmitter 122 and receiver 124 are illustrated. It shall be understood that the measurement device 120 can also have two or more transmitters 122 and associated receivers 124. In addition, the separately configured transmitter 122 and receiver 124 in FIG. 1 can also be configured in the form of transceivers. The at least one transmitter and receiver 122, 124 can be arranged at or in an extruder or injection moulding machine which is to be monitored, as is explained more closely further below in connection with FIG. 2. In addition, the measurement device 120 comprises a signal processing 126.

The at least one transmitter 122 of the measurement device 120 is designed to generate pulsed or continuous radar wave signals and to emit these to the material which is to be extruded (see also FIG. 2). The generated radar wave signals of each transmitter 122 can have at least a frequency in the range between 30 GHz to 300 GHz. The at least one receiver 124 is designed for the detection of the response signal generated through the material to be extruded and/or extrusion components or injection moulding components. The response signal can be the transmitted radar wave signal component (in transmission measurement) or the reflected radar wave signal component (in reflection measurement).

The signal processing unit 126 can be designed to determine from the detected response signals signal parameters such as run time Δt, intensity change ΔI and/or phase shift Δϕ of the radar wave signal. This takes place through comparison of the response signal with the emitted radar wave signal. The signal parameters determined by the signal processing unit can then be transferred (in the form of digital data) to the evaluation device 140. Alternatively hereto, the functionalities of the signal processing unit can be implemented in the calculating unit 142 of the evaluation device 140. In other words, according to an implementation deviating from FIG. 1, the signal processing unit 126 can also be part of the calculating unit 142 to the evaluation device 140.

The calculating unit 142 comprises at least one processor or integrated switching circuit. The calculating unit 142 is designed to determine at least one operating parameter on the basis of the determined signal run time Δt, intensity change ΔI and/or phase shift Δϕ. As is described in further detail in connection with FIGS. 3 to 5, from these operating parameters a conclusion can be drawn concerning the material composition and/or phase state (melting state) of the material (plastic material) received in the extruder.

The data memory 144 can be designed to store, briefly and/or in the long-term, the signal parameters determined in real time and the operating parameters determined therefrom. In the data memory 144 in addition models concerning the extruder or the injection moulding machine and/or refraction index models for the materials or respectively material mixtures which are to be extruded can be stored. Such refraction index models are described in greater detail further below in connection with FIGS. 4b and 4c.

Optionally, the measurement system 100 can further comprise an output device, which is designed to emit, visually and/or acoustically, the results of the calculating unit 142. The output device is not illustrated in FIG. 1. According to a variant, the results of the calculating unit 142 can be displayed on a screen of a computer, smartphone or other electronic device.

In connection with FIG. 2, an implementation of the measurement system 100 described above in an extruder 10 is described by way of example. The extruder 10 is designed as a single-screw extruder. It shall be understood that the measurement system described here does not depend on the practical configuration of the extruder 10 or of an injection moulding machine, but rather is able to be implemented in any type of extruder (single-screw extruder, double-screw extruder or multi-screw extruder) or injection moulding machine.

The extruder 10 comprises an extruder housing 12, a nozzle (die) or tool, arranged at the front axial end of the housing 12, at least one extruder screw 16, and a filling device 18. The housing 12 defines a rotationally symmetrical extruder channel 20 with rotation axis 22. In the extruder channel 20 the extruder screw 16 is arranged, which is rotatable about the rotation axis 22. The extruder screw 16 can, for example, be displaceable axially forward and back with respect to the face-side nozzle 14. The rotational movement and translational movement of the screw 16 takes place by a drive device which is arranged on the rear side of the extruder lying opposite the nozzle 14, and which is coupled to the screw 16 (not illustrated in FIG. 2).

The filling device 18 is coupled to the extruder channel 20. It serves to feed the material or material mixture which is to be extruded (generally plastic material) in the form of pellets or granulate to the extruder channel 20. As can be clearly seen in FIG. 2, the plastic material which is to be extruded is fed to the extruder channel 20 at its end facing away from the nozzle. This extruder region is also named the feed zone. Through the rotation of the screw 16 about the rotation axis 22, the plastic material, which is still initially present in the solid state in the feed zone, is moved in the direction of the nozzle. By heating the plastic material by means of heating elements 24 arranged on the extruder 10 and by friction of the moving plastic material against the screw or respectively against the inner wall of the extruder, the plastic material which is moved in the direction of the nozzle 14 is melted and compacted successively (compression zone or respectively melting zone of the extruder 10) until the plastic material is present in the region of the nozzle 14 (ejection zone of the extruder 14) in the desired plasticized state.

The measurement system 100 implemented in the extruder 10 comprises a measurement device 120 with a plurality of transceivers (transmitters and receivers 122, 124) which are arranged spaced apart from one another in axial direction of the extruder 10. By the use of several transceivers at different axial positions, the operating state can be monitored in each operating zone of the extruder. The evaluation device 140 of the measurement system 100 is configured separately from the measurement device 120 and is not illustrated further in FIG. 2.

Each transceiver 122, 124 arranged along the axial direction is in direct electromagnetic coupling with the extruder channel 20 of the extruder 10. A direct electromagnetic coupling is achieved for example by each transceiver 122, 124 being accommodated in the extruder channel 20 or in the extruder housing 12 (e.g. in recesses provided specifically for this on the inner wall of the extruder housing 12). Through the described coupling between transceiver 122, 124 and extruder channel 20 it is achieved that the radar wave signal generated by the transceiver 122, 124 is emitted in a loss-free manner (therefore without shielding) into the extruder channel 20. In FIG. 2 the emission of the radar wave signal into the extruder channel 20 is indicated diagrammatically. Equally, the response signal generated through the ray-penetrated plastic material and/or through reflection on extruder components (e.g. on the extruder screw or on the inner wall of the housing) can be detected by the transceivers 122, 124 without appreciable shielding or influencing by the extruder housing 12. The implementation of the measurement arrangement 100 shown in FIG. 2 measures as response signal the reflected radar wave signal (echo signal) incoming at each transceiver 122, 124. As in the implementation shown in FIG. 2 transceivers are arranged in the ejection zone, compression zone or respectively melting zone and feed zone, each extruder zone can be monitored separately by the described measurement system 100.

Alternatively to the implementation shown in FIG. 2, the measurement device 120 can also have spatially separate transmitters 122 and receivers 124 arranged lying opposite each other, in order to detect the transmitted radar wave signal as response signal.

The measurement method for monitoring the operating state of an extruder or injection moulding machine is described further by means of FIG. 3. The method is implemented by the measurement system 100 described in FIGS. 1 and 2.

In a first step S100 a radar wave signal is generated by means of at least one transmitter 122 and is emitted in an extruder (for example extruder 10) or respectively in an injection moulding machine. The radar wave signal has a predetermined frequency or frequencies. When several transmitters 122 are arranged in the extruder 10 (cf. FIG. 2), then each transmitter 122 emits a corresponding radar wave signal into the extruder channel 20.

The radar wave emitted by each transmitter 122 propagates through the plastic material which is received in the extruder channel 20 and is to be processed, and interacts with the wave-penetrated plastic material and the extrusion components situated in the propagation direction. For example, each radar wave signal propagating in the extruder channel 20 is reflected on the inner walls of the extruder housing 12 or on the screw surface. In a second step S200, the reflected radar wave signal is detected as a response signal by corresponding receivers 124.

In a subsequent third step S300, a signal run time Δt, intensity change ΔI and/or phase shift Δϕ of the radar wave signal is determined by means of the signal processing unit 126 or calculating unit 142 on the basis of each detected response signal. This takes place through comparison of each emitted radar wave signal (primary signal) with the response signal corresponding thereto, as described further above.

In a further step S400, at least one operating parameter for the extruder or injection moulding machine is determined by means of the calculating unit 142 on the basis of the determined run time Δt, phase shift Δϕ and/or intensity change ΔI of each emitted radar wave signal.

In connection with FIGS. 4a-4c, an implementation of step S400 is described further. FIG. 4a shows here a flow diagram which shows the determining of the refraction index n of a plastic material, received in the extruder or injection moulding machine and penetrated by radio waves, as operating parameter. It was found namely that the refraction index n of a plurality of plastic materials which can come into use in extrusion and injection moulding methods, changes sufficiently clearly during melting, so that this change becomes measurable with radar waves. It has further been found that the change of the refraction index n of plastic materials caused by a phase change (e.g. on the transition from the solid into the liquid state) is higher by at least one order of magnitude than a change of the refraction index n caused by temperature fluctuations or temperature changes in the material. Therefore, temperature influences on the refraction index can be disregarded. A typical refraction index development during the melting of plastic can be seen in FIG. 4b. The refraction index changes from a refraction index value n3 in the liquid (melted) state to a higher refraction index n4 in the solid (solidified) state. In the melting process, the refraction index lies between the two extreme values n3 and n4 and depends on the respective mixture ratio of solid and liquid phase. When the development of the refraction index n is known at the solid/liquid phase transition, then by measuring the refraction index n, a conclusion can be drawn easily concerning the mixing ratio of melt to solid material.

In addition, it has been found that the refraction index n of a plastic mixture of several components depends on the concentration of the respective components. FIG. 4c shows diagrammatically the development of the refraction index n of a melted plastic mixture of a component 1 and component 2. When the melt consists of two components which differ from one another measurably in their refraction index n1 and n2, then a conclusion can also be drawn concerning the mixture ratio of the two components 1 and 2 from the development of the refraction index n. This applies to a plurality of common plastic mixtures. This applies in particular to a plurality of foamed or degassed plastics, wherein the refraction index depends on the concentration of the included foaming agent or respectively on the degasification state of the plastic which is to be extruded. Therefore, for example, in the ejection zone of the extruder the material composition of the melt, such as for example the degasification state of the melt, the concentration of foaming agents in the melt or the concentration of other additives, fillers and/or reinforcing materials to be added to the melt, can be determined. As fillers, for example mineral fillers such as for example chalk, or functional fillers, such as for example metal particles, for changing the electrical and/or magnetic characteristics of the material, can come into use. As reinforcing materials, glass fibres, carbon fibres, natural fibres or other fibres can come into use for reinforcing the mechanical characteristics of the material. As additives, for example antioxidants, nucleating agents, dyes or other substances can come into use.

Back to FIG. 4a. The determining of the refraction index n as operating parameter takes place on the basis of the determined run time Δt, phase shift Δϕ and/or intensity change ΔI of the radar wave signal. For example, the refraction index n can be easily extracted from the determined signal run time Δt, as the signal run time Δt is indirectly proportional to the signal propagation speed Cm and the path Δs covered in the extruder channel 20 according to the equation Δt=Δs/Cm. As the signal propagation speed Cm in addition depends on the refraction index n of the ray-penetrated plastic material according to the equation Cm=Cv/n, wherein Cv is the refraction index of vacuum, the relationship Δt=n*Δs/Cv directly follows. As the refraction index Cv is known, with a known Δs, the refraction index n can be easily determined.

In order to determine from the determined refraction index n the material composition or the melting state of a plastic material which is to be processed, a corresponding refraction index model is provided (step 500a). A refraction index model describes the development of the refraction index n of a plastic material mixture as a function of its mixture ratio of melt to solid material (cf. FIG. 4b) and/or as a function of its material composition (cf. FIG. 4c). Such refraction index models can be determined for the respective plastic material mixtures through preliminary tests and stored in the data memory 144. Then, when carrying out the method according to the invention, they merely need to be retrieved through the calculating unit 142, whereby the real time monitoring only becomes possible. Additionally or alternatively hereto, a real time determining of refraction index models is also conceivable. Real time determining means the determining of a refraction index model during an extrusion process. For example, by means of the radar wave measurement technology described here, the refraction index n4 of the solid material present in the feed region of the extruder and the refraction index n3 of the completely melted material present in the ejection region of the extruder can be determined. From the two measured limit values n3 and n4 for the liquid and solid state of the material which is to be extruded, a conclusion can then be drawn concerning any desired mixture of solid and liquid phase in the extruder.

In the subsequent step S600a, the material composition and/or the melting state of the material which is to be extruded is determined on the basis of the determined refraction index n and the refraction index model. If, for example, the composition of the plastic material is (approximately) known, then the refraction index n depends only on the ratio of melt to solid material of the plastic material which is to be extruded. By means of a refraction index model, as illustrated in FIG. 4c, then with a determined refraction index n the melting state of the plastic material which is to be extruded can be determined. If, on the other hand, the melting state is known, e.g. through evaluation of temperature data which were measured by temperature sensors arranged at the extruder or respectively at the injection moulding machine, the material composition of the plastic material which is to be extruded can be determined by means of a refraction index model, as illustrated in FIG. 4b.

In connection with FIG. 5, a further implementation of an operating parameter (method step S400 in FIG. 3) is described. In this implementation, the wear state of the extruder 10 or respectively of the injection moulding machine is determined.

According to a first step S400b, by means of the calculating unit 142 on the basis of the determined run time Δt, phase shift Δϕ and/or intensity change ΔI of the radar wave signal, at least one distance information datum between components of the extruder or respectively injection moulding machine is determined. For example, in the extruder 10 shown in FIG. 2, the distance D between the extruder screw 16 and the housing 14 can be determined. This distance can be easily determined from the determined signal run time Δt of the radar wave signal, because this is proportional to the path Δs of the radar wave signal which is covered according to the relationship Δt=n*Δs/Cv. If the refraction index n of the plastic material which is to be extruded is n, then the covered path Δs can be determined directly from the measured signal run time Δt. In the implementation of the measurement device 100 illustrated in FIG. 2, in which the radar wave signal reflected by the screw 16 can be measured as response signal, the distance between screw 16 and extruder housing is precisely half the measured signal path, therefore 0.5*Δs=D.

From the determined distance D (distance changes), in a further step S500b the wear of the screw 16 can be estimated.

The determining of the wear described in connection with FIG. 5 can in particular also be carried out with an emptied extruder or outside the operation of the extruder.

The technology described here enables, in a flexible and simple manner, the determining of the material composition and of the melting state of a material which is to be extruded. In particular, the method can also be used for determining the wear of extruder components. As the electromagnetic radar waves do not depend on the temperature conditions in the extruder or in the injection moulding machine, the present invention concerns a monitoring technology which is decoupled from temperature influences. In addition, the technology can be used in any desired extruder or injection moulding machine. The use of the technology in the injection tool of an injection moulding machine, in order for example to monitor the cooling phase of the produced shaped parts is also conceivable.

What is claimed is:

1. A method for monitoring an extruder which is in operation or an injection moulding machine which is in operation, wherein the method comprises the following steps:
emitting a radar wave signal in the extruder or in the injection moulding machine;
detecting a response signal corresponding to the emitted radar wave signal;
determining a run time Dt, phase shift Df and/or intensity change DI of the radar wave signal on the basis of the detected response signal; and
determining at least one operating parameter on the basis of the determined run time Dt, phase shift Df and/or intensity change DI of the radar wave signal, wherein the operating parameter points to a wear state of the extruder or of the injection moulding machine, a melting state and/or a material composition of a material which is received in the extruder or in the injection moulding machine and which is to be processed.

2. The method according to claim 1, wherein the radar wave signal in the extruder or in the injection moulding machine is emitted at several positions arranged spaced apart from one another in axial direction and/or radial direction, and wherein for each position the response signal is detected and an operating parameter is determined on the basis of the response signal.

3. The method according to claim 1, wherein as response signal a reflection component or a transmission component of the irradiated radar wave signal is detected.

4. The method according to claim 1, wherein the radar wave signal is emitted at a predetermined angle to an extrusion direction.

5. The method according to claim 1, wherein the radar wave signal is a continuous or pulsed radar signal.

6. The method according to claim 1, wherein the emitted radar wave signal has at least a frequency in the range between 30 GHZ and 300 GHZ.

7. The method according to claim 1, wherein as operating parameter the refraction index n of the material which is to be processed is determined form the determined run time Dt, phase shift Df and/or intensity change DI.

8. The method according to claim 7, wherein from the determined refraction index n by means of at least one refraction index model the material composition and/or the phase state of the material which is to be processed is determined.

9. The method according to claim 1, wherein as operating parameter a distance datum D is determined from the determined run time Dt, phase shift Df and/or intensity change DI.

10. The method according to claim 9, wherein from the distance information D by means of a model describing the extruder or the injection moulding machine, the wear state of the extruder or of the injection moulding machine is determined.

11. A measurement system, which is designed for monitoring an extruder or an injection moulding machine in operation, comprising:
a measurement device, which is designed to generate a radar wave signal and to emit it in the extruder or in the injection moulding machine, and to detect a response signal corresponding to the emitted radar wave signal; and
an evaluation device, which is designed to determine a run time Dt, phase shift Df and/or intensity change DI of the radar wave signal on the basis of the detected response signal, and to determine at least one operating parameter of the extruder or of the injection moulding machine on the basis of the determined run time Dt, phase shift Df and/or intensity change DI of the radar wave signal,
wherein the operating parameter points to a wear state of the extruder or of the injection moulding machine, to a melting state and/or to a material composition of a material which is received in the extruder or in the injection moulding machine and which is to be processed.

12. The measurement system according to claim 11, wherein the measurement device comprises at least one transmitter for generating the at least one radar wave signal at the at least one measurement position, and at least one receiver for detecting a response signal corresponding to the radar wave signal.

13. The measurement system according to claim 11, wherein the measurement device is designed to emit and detect radar waves in the range between 30 GHZ to 300 GHZ.

14. The measurement system according to claim 11, wherein the evaluation device is designed to determine a refraction index of the material which is received in the extruder or in the injection moulding machine and which is to be processed, on the basis of the detected run time Dt, phase shift Df and/or intensity change DI, and to determine the phase state and/or the material composition of the material by means of a predetermined refraction index model.

15. The measurement system according to claim 11, wherein the evaluation device is designed to determine distances between components of the extruder or of the injection moulding machine on the basis of the detected run time Dt, phase shift Df and/or intensity change DI, and to determine the wear state of the extruder or of the injection moulding machine by means of a predetermined model.

16. The measurement system according to claim 11, further comprising a memory device, which is designed to store at least one refraction index model and/or a model describing the extruder or the injection moulding machine, or parameters.

17. An extruder, comprising the measurement system according to claim 11.

18. An injection moulding machine, comprising the measurement system claim 11.
